(19) United States
(12) Patent Application Publication
(10) Pub. No.: US 2014/0308095 A1
(43) Pub. Date: Oct. 16, 2014

(54) SYSTEM WITH ONE OR PLURAL COVERS FOR BINDING A STACK OF SHEETS AND COVER, BINDING APPARATUS AND METHOD FOR BINDING THE STACK OF SHEETS

(71) Applicant: Swedex GmbH & Co. KG, Essen (DE)

(72) Inventor: Bernd Loibl, Klettgau (DE)

(21) Appl. No.: 14/192,159

(22) Filed: Feb. 27, 2014

(30) Foreign Application Priority Data
Apr. 12, 2013 (DE) 202013003427.0

(51) Int. Cl. B42C 11/02

(52) U.S. Cl. CPC B42C 11/02
USPC 412/20

(57) ABSTRACT

The invention relates to a cover for binding a stack of sheets provided with a cover back and cover sheets, wherein the cover back is provided on its inside with a melt glue strip, wherein the cover is provided with at least one identification element, in particular a transponder, in particular a RFID transponder, including an identification feature which is detectable by a reader touch free. The invention furthermore relates to an office binding apparatus with a reader for detecting the identification feature and a system including the cover and the office binding apparatus.

### RELATED APPLICATIONS

This application claims priority from and incorporates by reference German Utility Model 20 2013 003 427.0 filed on Apr. 12, 2013.

### FIELD OF THE INVENTION

The invention relates to a system with one or plural covers for binding a stack of sheets to form a brochure and it also relates to an associated binding apparatus configured as a piece of office binding equipment. Furthermore the invention relates to a cover and a method for binding the stack of sheets using the system.

### BACKGROUND OF THE INVENTION

It is well known to produce company brochures, financial reports and marketing material in house that means in one's own office by binding a stack of sheets representing the content in a cover including a cover back and cover sheets adjoining at longitudinal edges of the cover back. For this purpose the cover back includes a strip of melt glue at its inside. In order to perform the binding process a combination including the stack of sheets and the cover is inserted into an office binding apparatus and the cover back is heated so that the glue strip plasticizes, this means it melts and the faces of the stack of sheets contacting the glue strip sink into the glue strip. After taking the combination out of the office binding apparatus the glue strip cools down and thus forms a firm connection of the stack of sheets with the binder.

Suitable office binding apparatuses, they are also designated as thermal binders are known for example from U.S. Pat. No. 3,973,787 A, U.S. Pat. No. 4,141,100 A, U.S. Pat. No. 4,367,116 A, EP 0 396 037 A2, DE 38 05 830 T2 and DE 10 2004 037 806 A1. These are typically table top units that are placed on an office desk. They have a unit housing with an insertion hopper that is open in upward direction and which is terminated by a heating plate in insertion direction, this means typically in vertically downward direction. For a binding operation the combination of sheets stack and cover is placed so that an outside of the cover back rests on the heating plate. In order for the combination to maintain its predetermined, typically vertical position the office binding apparatus typically includes a pressing device which compresses the combination perpendicular to the planes of the cover sheets. Typically the pressing device is configured so that at least one of the side walls defining the insertion hopper is moveably supported in a direction towards the other side wall so that a width of the insertion hopper is variable and the combination can be held in a pressed condition between the two side walls.

The heating plates of the office binding apparatus recited supra are coupled with an electronic control device. The electronic control device determines duration of the binding cycle. Thus a binding cycle is a time period that is determined by the control device through a predetermined beginning and a predetermined end, wherein the end of the binding cycle is typically indicated by an annunciator signal. Thereafter the heating plate is turned off, switched to a stand by mode with increased temperature or maintained for a predetermined time at a temperature of the preceding binding cycle. Embodiments for such control devices can be derived from EP 0 202 442 A2 and DE 44 28 707 A1.

Thermal energy that is required for melting the glue strip is a function of the volume of the glue strip and thus presuming identical format of the combination of sheet stack and cover primarily a function of the width of the cover and thus of the width of the glue strip and also of its thickness but also a function of a thickness of the cover back that impedes heat transfer from the heating plate to the glue strip. This is widely but not completely compensated so that the heat transfer surface and thus the thermal energy transmitted during a binding cycle is the greater, the wider the back of the cover. As a corrective measure it is known in the art to adjust a duration of the binding cycle through an actuation device that is externally operable as a function of the type of cover used and as a function of the thickness of the sheet stack to be bound (c.f. EP 0 202 442 A2, column 1 lines 41-44). For the known office binding apparatuses this is only performed in few and thus coarse increments. An adaptation to the actually required thermal energy is thus rather coarse.

Another advantage of known office binding apparatuses is that commercially available covers typically lack information how the control device shall be manually adjusted. Therefore operator errors and insufficient binding of the stack of sheets occurs quite frequently. Even when information regarding the width and thickness of the cover back are provided operator errors when adjusting the duration of the binding cycle according to the information provided occur quite frequently through negligence.

### BRIEF SUMMARY OF THE INVENTION

Thus it is an object of the invention to prevent faulty bindings in office binding apparatuses of the type recited supra in a more reliable manner. This object is achieved according to the invention by a binding system, including at least one cover for binding a stack of sheets to form a brochure; and an office binding apparatus for binding the stack of sheets with the at least one cover, wherein the at least one cover includes a cover back and cover sheets adjoining at longitudinal edges of the cover back and the cover back includes a melt glue strip at an inside of the cover back, wherein the office binding apparatus includes an insertion hopper with a heating plate defining the insertion hopper in an insertion direction, wherein the heating plate is coupled with a control device for adjusting a heating power of the heating plate, wherein the at least one cover includes at least one identification element including an identification feature which is specific for an amount of thermal energy that is required for melting the melt glue strip, wherein the office binding apparatus includes at least one reader for detecting the identification feature touch free, wherein the reader and the control device cooperate after detecting the identification feature so that an amount of thermal energy transmitted in a binding cycle, in particular a duration of the binding cycle is automatically adapted according to the detected identification feature and/or wherein the reader cooperates with a display device after detecting the identification feature so that the display device puts out a display according to the detected identification feature and the control device includes an actuation device that is operable to adjust the duration of the binding cycle.

Therefore it is a core idea of the invention to provide an intelligent cover which is configured to communicate with a reading device of the office binding apparatus and thus to provide information (identification feature) to the office binding apparatus that is processable in a control device regarding an amount of thermal energy required for melting the glue strip. Based on this information the amount of thermal energy transferred in a binding cycle is adapted accordingly, thus advantageously by adjusting duration of the binding cycle. This, however, does not preclude that an adjustment is also provided through the temperature of the heating plate during the binding cycle.

Due to the adjustment of the required amount of thermal energy automatically performed through the identification element of the cover operator errors and thus faulty bindings of the sheet stacks in the covers are excluded. Furthermore the absorbed electrical energy can be significantly reduced through tight adaptation of the identification element or its identification feature to the required amount of thermal energy. Also the duration of the binding cycle itself can typically be significantly reduced through this adaptation compared to the coarse increments provided by known office binding apparatuses.

Alternatively or in combination with the described solution it is provided according to the invention that the reading device interacts with a display device after detecting the identification feature so that it puts out a display according to the identification feature and the control device includes an actuatable operating device for adjusting the duration of the binding cycle. However, this solution still requires activity of an operator. The operator, however, receives clear and unambiguous information through the display device how the actuation device has to be adjusted. Thus, the operator can be instructed to do so through an acoustic or optical annunciator like an acoustic warning signal or a flashing display. Furthermore it can be provided through a respective circuit that a binding cycle is only initiated when the actuation device has been adapted to the respective display. Even when this embodiment of the core idea of the invention does not function fully automatically it has the advantage that the display is much more precise and therefore the adjustment of the duration of the binding cycle is adapted to the actual thermal energy requirement in a much more reliable and better manner.

Various embodiments of identification elements can be used for the invention. Thus, there is an option to provide the cover with a code which is for example optically scanned with a laser. Such codes can be bar codes, QR codes or embossings or a whole pattern. Identification elements are more elegant which can be hidden in the cover so that they are not visible from the outside and thus do not interfere with an optical appearance of the cover. This can be for example magnetic or magnetizable elements whose individual magnetic field or individual magnetizeability can be detected as identification features by respective reading devices. They can be attached for example at an inside of one of the cover sheets and thus optimally close to the cover back, but they can also be encapsulated between an inside of the cover back and the glue strip.

Electronic identification elements and thus in particular so called transponders more precisely RFID transponders are particularly suitable. These can currently be configured very small in particular when they are configured as passive transponders. A reading device configured for reading out such transponders generates a high frequency electromagnetic alternating field which activates the transponder. The transponder configured as identification feature influences the transmission field of the read out device so that the read out device obtains respective information which is then converted into a signal that is suitable for the control device. The transponders can be configured in increments that are fine enough with respect to their respective identification feature so that the control device transmits a precisely adapted amount of thermal energy to the glue strip within a binding cycle so that on the one hand side a complete melting of the glue strip is provided, and on the other hand side excessive heat influx after completion of the melting process is prevented.

Thus not only the entire system including covers and office equipment but also a cover which includes at least one identification element e.g. one of the identification elements described supra, in particular a RFID transponder are subject matters of the invention, wherein the identification element includes an identification feature which is detectable touch free by a reading device. The identification element shall be configured as a passive element so it can be sized as small as possible so that it is hardly detectable at the cover or so that it can even be encapsulated between glue strip and cover back.

Furthermore the invention relates to a cover set that includes plural covers, wherein the cover backs have different width and/or thickness and the identification elements have an identification feature that is characteristic for the width and/or thickness of the cover back. Thus, the identification elements are configured with respect to their identification features so that information corresponding to a width and/or thickness of the cover back is transmitted or transmittable as an identification feature in combination with a respective office binding apparatus.

Another object of the invention is an office binding apparatus including at least one reading device for touch free detection of an identification element including an identification feature. An office binding apparatus of this type is configured to read out an identification element that is arranged at a cover and that is adapted to the read out device and to receive respective information as an identification feature which is useable for controlling the office binding apparatus e.g. in a manner so that the amount of thermal energy transferred in the binding cycle through an interaction between reading device and control device, in particular the duration of the binding cycle is automatically adapted according to the read out identification feature. Alternatively thereto or in combination therewith it can be provided that the reading device interacts with a display device after detecting the identification feature, so that it puts out a display according to the identification feature and the control device includes an operable actuation device for adjusting the duration of the binding cycle. An office binding device of this type is configured to communicate with covers that are provided with identification elements whose identification features are readable through the reading device.

The reading device is advantageously arranged below the heating plate. This arrangement is advantageous in particular when the identification element is attached at the back of the binder. In spite of that or in combination there with the reading device can also be arranged adjacent to the side walls defining the insertion hopper.

In another embodiment of the invention it is provided that the reading device and control device interact so that a binding cycle is only initiated or initiate able when the reading device has read an identification element. Furthermore the reading device should be arranged so that an identification element arranged at a cover is only readable when the cover is inserted into the insertion hopper. This way it is assured that the binding cycle is only started when the combination of cover and sheet stack is actually arranged in the insertion hopper ready to be bound.

The insertion hopper can be configured open in upward direction, wherein a slanted arrangement of the insertion hopper is also feasible. Advantageously, however, the support walls should extend in vertical planes. In order to keep the combination of cover and sheets stack in a predetermined position during the binding process the insertion hopper should include at least one support wall which is moveable in a direction towards an opposite support wall. This does not exclude that both support walls are moveably supported relative to one another. The movabililty can be configured as a pivot movement, advantageously as a sliding movement.

Another object of the invention is a method for binding a stack of sheets to form a brochure, wherein the stack of sheets is inserted into a cover with a cover back that is internally provided with a melt glue strip and cover sheets adjoining at longitudinal edges of the cover back so that the sheet stack contacts the glue strip with a face of the sheet stack and wherein the combination of cover and sheet stack is inserted into the insertion hopper of the office binding apparatus so that the cover back contacts a heating plate with an outside of the cover back which heating plate defines the insertion hopper in insertion direction and wherein the thermal energy transferred in a binding cycle is adjustable through a control device so that the glue strip of the cover is melted. According to the invention the cover described supra is used for this binding cycle, thus the cover with the identification feature and an office binding apparatus as described supra, wherein the identification feature of the identification element is read by a reading device of the office binding apparatus and the combination of binder and sheet material is loaded in the binding cycle at least with an amount of thermal energy that corresponds to the identification feature.

### BRIEF DESCRIPTION OF THE DRAWINGS

The invention is now described based on an embodiment with reference to schematic drawing figures, wherein:

FIG. 1 illustrates a first cover according to the invention in a perspective view;

FIG. 2 illustrates a second cover according to the invention is a perspective view.

FIG. 3 illustrates a vertical sectional view of a binding apparatus with an inserted cover according to FIG. 1; and

FIG. 4 illustrates a vertical sectional view through the binding apparatus according to FIG. 3 in the same plane, however with an inserted cover according to FIG. 2.

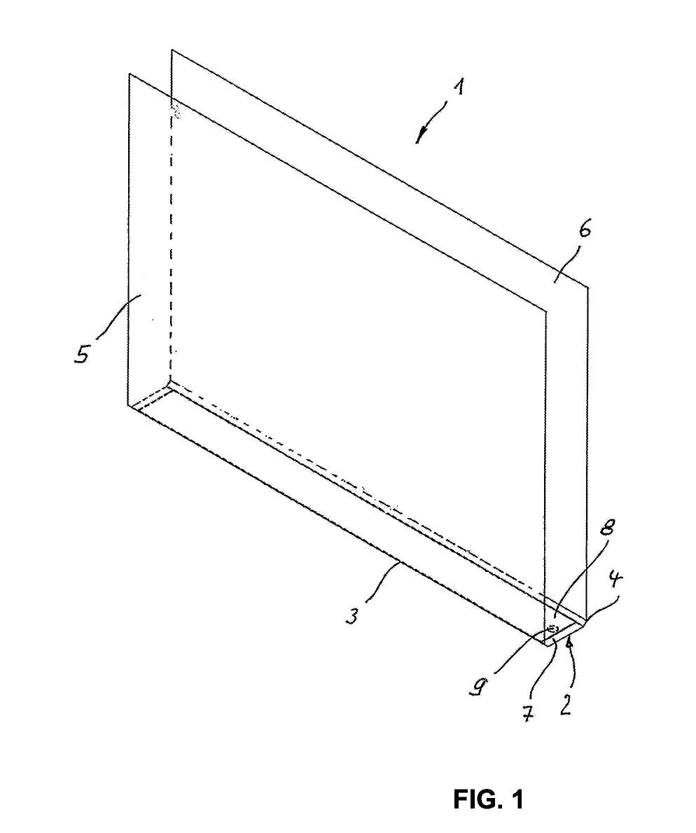

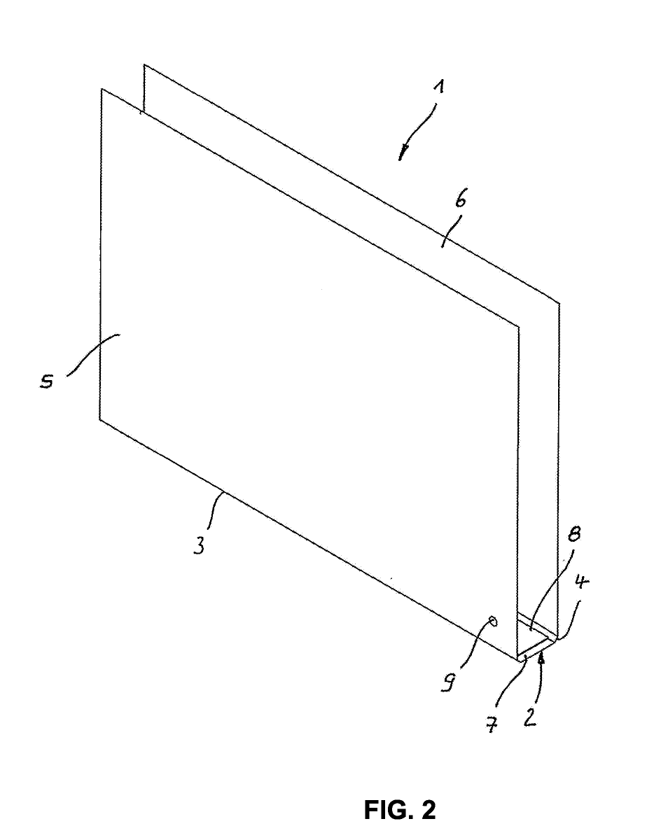

FIGS. 1 and 2 besides a variation described infra illustrate two identical covers 1. Therefore identical reference numerals are used for the covers 1 and for their elements. The covers 1 include an elongated, rectangular cover back 2, at whose longitudinal edges 3, 4 identically sized rectangular cover sheets 5, 6 are respectively attached through creases. In the illustrated position, the cover sheets extend parallel to one another. Through the creases at the longitudinal edges 3, 4 the cover sheets 5, 6 are pivotable relative to the cover back 2. Typically the cover sheets 5, 6 have approximately DIN-A4 or letter size format. It is not excluded that also other formats are used for the cover sheets 5, 6.

At the inside 7 of the cover back 2 a glue strip 8 made from commercially available melt glue is attached which extends almost over an entire length and width of the cover back 2. The glue strip is firmly connected with the inside of the cover back 2 in that it is applied to the cover back 2 in molten condition or in that it is applied through a pressure sensitive contact glue.

Both covers 1 include a passive RFID transponder 9. In the embodiment according to FIG. 1 the RFID transponder 9 is encapsulated between an inside of the cover back 2 and a bottom side of the glue strip 8 at a distal end of the glue strip 8. In this embodiment according to FIG. 2 the RFID transponder 9 is applied at the distal cover sheet 5 thus proximal to the longitudinal edge 3 of the cover back 2 and at the distal vertical edge of the cover sheet 5.

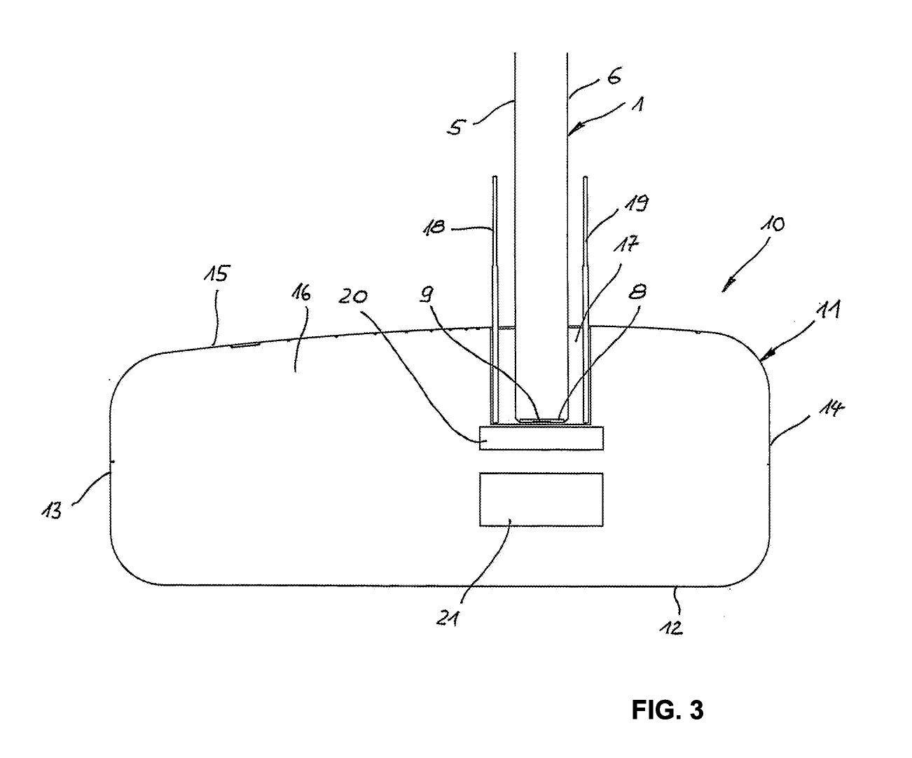

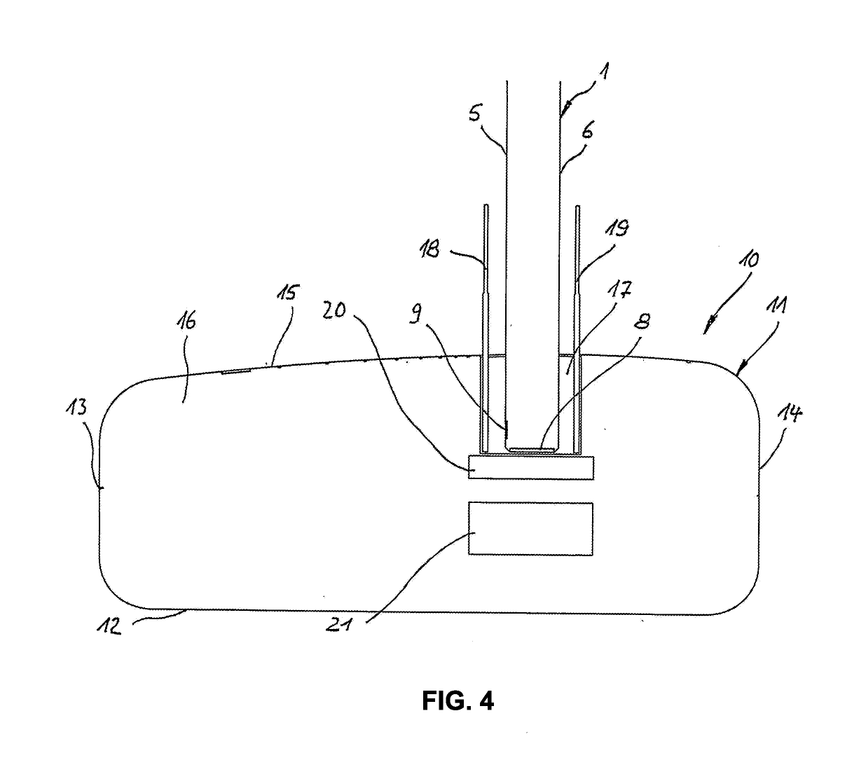

FIGS. 3 and 4 illustrate an office binding apparatus 10 in a typical table top unit configuration, thus in a vertical sectional view and reduced to the components that are essential for the present invention. The office binding apparatus 10 has an essentially rectangular unit housing 11 with a base wall 12 as a placement surface, a front wall 13 and parallel thereto a rear wall 14 and a top wall 15. The base wall 12, the front and rear wall 13, 14 and the top wall 15 are connected through rounded corners and extend with this shape perpendicular to the drawing plane. Parallel to the drawing plane they are connected through a first face wall that is not visible in the drawing and a visible second face wall 16 which generates a closed unit housing 11.

The top side wall 15 is interrupted by an insertion hopper 17. Its extension perpendicular to the drawing plane is slightly greater than the longitudinal extension of the cover 1 according to FIGS. 1 and 2. The insertion hopper 17 is open in upward direction and is defined on both sides by upward protruding support walls 18, 19. The left side support wall 18 is moveable in horizontal direction towards the right side support wall 19 in order to change the width of the insertion hopper 17. The movability can be controlled by a motor. On the bottom side the insertion hopper 17 is defined by a heated plate 20.

In the illustration according to FIG. 3 the cover 1 according to FIG. 1 is inserted into the insertion hopper 17 and according to FIG. 2 the cover 1 according to FIG. 1 is inserted into the insertion hopper 17 so that a respective outside of the cover back 2 is placed flat on the top side of the heating plate 20 and the cover sheets 5, 6 protrude vertically upward from the insertion hopper 17. Before inserting the cover 1 into the insertion hopper 17 a sheet stack that is not illustrated in more detail is inserted between the cover sheets 5, 6 so that its lower face formed by the lower edges of the individual sheets contacts the glue strip 8. In order to support the cover 1 in the illustrated position the left support wall 18 is moved towards the right support wail 19 until the sides of the support walls 18, 19 that are oriented towards one another contact the respective cover sheets 5 or 6 with their surfaces.

The RFID transponder 9 depending on its arrangement either at the cover back 2 or at the cover sheet 5 is specifically adapted to the amount of thermal energy required for complete melting of the glue strip 8. Below the heater plate 20 a RFID reader 21 is fixated at the unit. This RFID reader 21 is connected with a control device which is not illustrated in more detail herein which in turn is electrically coupled with the heating plate 20. The RFID reader 21 is adapted to the RFID transponder 9 so that a high frequency electromagnetic alternating field generated by the RFID reader 21 activates the RFID transponder 9 which has the consequence that the alternating field is individually influenced for example by weakening the field. The type of influencing represents an identification feature of the RFID transponder 9 which is processed as information by the RFID reader 21 and is forwarded as a signal to the control device for the heater 20.

For a binding process the cover 1 with the sheet stack is inserted into the insertion hopper 17 in the manner illustrated in FIGS. 3 and 4. The RFID reader 21 automatically reads out the RFID transponder 9 in described manner described supra. The identification feature thus read out is converted into a signal which adapts the control device to the duration of the binding cycle according to the identification feature of the RFID transponder 9. The identification feature of the RFID transponder 9 is configured so that the amount of thermal energy required for completely melting the glue strip 8 is relatively exactly transferred from the heating plate 20 through the binder back 2 to the glue strip 8 during the binding cycle which is adapted this way with respect to its duration. The end of the binding cycle is then indicated through an optical signaling device at an outside of the unit housing 11 preferably at the upper side wall 15 so that the operator can remove the combination of cover 1 and sheet material inserted therein from the insertion hopper 17 in upward direction and can place it on a cooling stand. The sheet stack that has sunk into the glue strip 8 enters a firm bond with the cover back 2 when the glue strip cools. The completion of the binding cycle can also be used to reduce the amount of electrical energy supplied to the heating plate 20 or even to cut it off completely.

What is claimed is:

1. A binding system, comprising:
at least one cover for binding a stack of sheets to form a brochure; and
an office binding apparatus for binding the stack of sheets with the at least one cover,
wherein the at least one cover includes a cover back and cover sheets adjoining at longitudinal edges of the cover back and the cover back includes a melt glue strip at an inside of the cover back,
wherein the office binding apparatus includes an insertion hopper with a heating plate defining the insertion hopper in an insertion direction,
wherein the heating plate is coupled with a control device for adjusting a heating power of the heating plate,
wherein the at least one cover includes at least one identification element including an identification feature which is specific for an amount of thermal energy that is required for melting the melt glue strip,
wherein the office binding apparatus includes at least one reader for detecting the identification feature touch free, and
wherein the reader and the control device cooperate after detecting the identification feature so that an amount of thermal energy transmitted in a binding cycle is automatically adapted according to the detected identification feature, or the reader cooperates with a display device after detecting the identification feature so that the display device puts out a display according to the detected identification feature and the control device includes an actuation device that is operable to adjust the duration of the binding cycle.

2. The binding system according to claim 1,
wherein the at least one identification element is a RFID transponder.

3. The binding system according to claim 2,
wherein the at least one identification element is attached at the cover back between an inside of the cover back and the melt glue strip, or
wherein the at least one identification element is attached at one of the cover sheets, in a half of the cover sheet that is adjacent to the cover back, or at an inside of the cover sheets.

4. The cover according to claim 2, wherein the at least one identification element is passive.

5. A cover set including plural covers according to claim 2,
wherein each of the cover backs have a different width or thickness and the identification elements include an identification feature that characterizes the width or the thickness of the cover back.

6. An office binding apparatus for binding a stack of sheets in a cover,
wherein the office binding apparatus is configured according to claim 1.

7. The binding system according to claim 1,
wherein the reader and the control device cooperate after detecting the identification feature so that an amount of thermal energy transmitted in a binding cycle is automatically adapted according to the detected identification feature, and
wherein the reader cooperates with a display device after detecting the identification feature so that the display device puts out a display according to the detected identification feature and the control device includes an operable actuation device for adjusting the duration of the binding cycle.

8. The office binding apparatus according to claim 6, wherein the control device is configured so that the amount of thermal energy transmitted during the binding cycle is adjusted by changing a duration of the binding cycle.

9. The office binding apparatus according to claim 6, wherein the reader is arranged below the heating plate or adjacent to support walls defining the insertion hopper.

10. The office binding apparatus according to claim 6, wherein the reader and the control device cooperate so that a binding cycle is only initiated when the reader has detected the identification element.

11. The office binding apparatus according to claim 6, wherein the reader is arranged so that the identification element arranged at the cover is only readable when the cover is inserted into the insertion hopper.

12. The office binding apparatus according to claim 6, wherein the insertion hopper is open in upward direction and has support walls which extend in vertical planes.

13. The office binding apparatus according to claim 6, wherein the insertion hopper includes at least one support wall that is moveable in a direction towards an opposite support wall.

14. A method for binding a stack of sheets, comprising the steps:
inserting a stack of sheets into a cover including a cover back that includes a melt glue strip at its inside and cover sheets adjoining at longitudinal edges of the cover back so that the stack of sheets contacts the melt glue strip with a face of the stack of sheets to form a combination of the stack of sheets with the cover;
inserting the combination of the cover and the stack of sheets into an insertion hopper of an office binding apparatus so that the cover back contacts a heating plate with an outside of the cover back which heating plate defines the insertion hopper in insertion direction;
adjusting an amount of thermal energy transferred in a binding cycle through a control device so that the melt glue strip of the cover is melted;
using the binding system according to claim 1 for the method;
detecting the identification feature of the identification element arranged at the cover with a reader of the office binding apparatus;
loading the combination of the cover and the stack of sheets during the binding cycle at least with an amount of thermal energy that corresponds to the detected identification feature.

15. A binding system, comprising:
at least one cover for binding a stack of sheets; and
an office binding apparatus for binding the stack of sheets with the at least one cover,
wherein the at least one cover includes a cover back and cover sheets adjoining at longitudinal edges of the cover back and the cover back includes a melt glue strip at an inside of the cover back,
wherein the office binding apparatus includes an insertion hopper with a heating plate defining the insertion hopper in an insertion direction,
wherein the heating plate is coupled with a control device for adjusting a heating power of the heating plate,
wherein the at least one cover includes at least one identification element including an identification feature which is specific for an amount of thermal energy that is required for melting the melt glue strip,
wherein the office binding apparatus includes at least one reader for detecting the identification feature touch free,
wherein the reader and the control device cooperate after detecting the identification feature so that an amount of thermal energy transmitted in a binding cycle is automatically adapted according to the detected identification feature, and
wherein the reader cooperates with a display device after detecting the identification feature so that the display device puts out a display according to the detected identification feature and the control device includes an actuation device that is operable to adjust the duration of the binding cycle.

16. A binding system according to claim 15, wherein the at least one cover for binding a stack of sheets to form a brochure.

17. The at least one cover according to claim 2,
wherein the identification element is attached at the cover back between an inside of the cover back and the melt glue strip, or
wherein the identification element is attached at one of the cover sheets in a half of the cover sheet that is adjacent to the cover back and at an inside of the cover sheet.

18. A cover set including plural covers according to claim 2,
wherein the cover backs have different width and thickness and the identification elements include an identification feature that characterizes the width and the thickness of the cover back.
